(19) United States
(12) Patent Application Publication
(10) Pub. No.: US 2025/0048270 A1
(43) Pub. Date: Feb. 6, 2025

(54) INDIVIDUAL TWT OPERATION FOR PEER-TO-PEER NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei (TW)

(21) Appl. No.: 18/783,301

(22) Filed: Jul. 24, 2024

Related U.S. Application Data
(60) Provisional application No. 63/530,877, filed on Aug. 4, 2023.

(51) Int. Cl. H04W 52/02

(52) U.S. Cl. CPC H04W 52/0258

(57) ABSTRACT

A first station (STA) device in a wireless network, the first STA device comprising a memory and a processor coupled to the memory, the processor is configured to transmit, to a second STA, a first frame that includes a TWT element comprising one or more target wake time (TWT) parameters for establishing a TWT agreement, wherein the first STA and the second STA are in a peer-to-peer (P2P) network, receive, from the second STA, a second frame that accepts the TWT agreement, and establish the TWT agreement between the first STA and the second STA.

### CROSS-REFERENCE TO RELATED APPLICATIONS

This application claims the benefit of priority from U.S. Provisional Application No. 63/530,877, entitled “Individual TWT Operation for Peer-to-Peer Networks” filed Aug. 4, 2023, which is incorporated herein by reference in its entirety.

### TECHNICAL FIELD

This disclosure relates generally to a wireless communication system, and more particularly to, for example, but not limited to, individual target wake time (TWT) operation for peer-to-peer (P2P) networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first station (STA) in a wireless network. The first STA comprises a memory and a processor coupled to the memory. The processor is configured to transmit, to a second STA, a first frame that includes a TWT element comprising one or more target wake time (TWT) parameters for establishing a TWT agreement, wherein the first STA and the second STA are in a peer-to-peer (P2P) network. The processor is configured to receive, from the second STA, a second frame that accepts the TWT agreement. The processor is configured to establish the TWT agreement between the first STA and the second STA.

In some embodiments, the TWT agreement specifies TWT service periods (SPs) such that the first STA and the second STA are expected to be awake during the TWT SPs specified in the TWT agreement.

In some embodiments, the first STA intends to be in a doze state outside of the TWT service SPs specified in the TWT agreement.

In some embodiments, the first frame is a TWT setup request frame that includes the TWT element with a responder power management (PM) mode subfield that specifies whether the first STA intends to be in the doze state outside of the TWT service SPs.

In some embodiments, the second frame is a TWT setup response frame that includes a TWT setup command field set as Accept TWT.

In some embodiments, the first STA is a P2P group owner and the second STA is a P2P client in the P2P network.

In some embodiments, the first STA is a P2P client and the second STA is a P2P group owner in the P2P network.

In some embodiments, the processor is further configured to establish another TWT agreement between the first STA and a third STA that is not in the P2P group.

In some embodiments, the first STA and the second STA do not support null data packet (NDP) paging for the TWT agreement such that an NDP paging indicator subfield in a TWT element indicates that NDP paging is not supported.

In some embodiments, the TWT agreement is a trigger-enabled TWT agreement.

In some embodiments, the first STA and the second STA support subchannel selective transmission (SST) operation such that the TWT agreement is subchannel-based TWT transmission.

One aspect of the present disclosure provides a first station (STA) in a wireless network. The first STA comprises a memory and a processor coupled to the memory. The processor is configured to receive, from a second STA, a first frame that includes a TWT element comprising one or more target wake time (TWT) parameters for establishing a TWT agreement, wherein the first STA and the second STA are in a peer-to-peer (P2P) network. The processor is configured to transmit, to the second STA, a second frame that accepts the TWT agreement. The processor is configured to establish the TWT agreement between the first STA and the second STA.

In some embodiments, the TWT agreement specifies TWT service periods (SPs) such that the first STA and the second STA are expected to be awake during the TWT SPs specified in the TWT agreement.

In some embodiments, the first STA intends to be in a doze state outside of the TWT service SPs specified in the TWT agreement.

In some embodiments, the second frame is a TWT setup response frame that includes a TWT setup command field set as Accept TWT.

In some embodiments, the first STA is a P2P group owner and the second STA is a P2P client in the P2P network.

In some embodiments, the first STA is a P2P client and the second STA is a P2P group owner in the P2P network.

In some embodiments, the processor is further configured to establish another TWT agreement between the first STA and a third STA that is not in the P2P group.

In some embodiments, the first STA and the second STA do not support null data packet (NDP) paging for the TWT agreement such that an NDP paging indicator subfield in a TWT element indicates that NDP paging is not supported.

In some embodiments, the first STA and the second STA support subchannel selective transmission (SST) operation such that the TWT agreement is subchannel-based TWT transmission.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 shows an example of individual TWT operation in accordance with an embodiment.

FIG. 5 illustrates a P2P client and a legacy client being connected with a P2P GO in a star configuration in accordance with an embodiment.

FIG. 6 illustrates a P2P group with only a client and a P2P GO in accordance with an embodiment.

FIG. 7 illustrates an initiation of an individual TWT negotiation by a P2P client in accordance with an embodiment.

FIG. 8 illustrates an initiation of individual TWT negotiation by a P2P Group Owner in accordance with an embodiment.

FIG. 9 illustrates an individual TWT negotiation between two P2P clients in accordance with an embodiment.

FIG. 10A shows an example of a TWT element in accordance with an embodiment.

FIG. 10B illustrates another example of a TWT element in accordance with an embodiment.

FIG. 11 illustrates an example format of the TWT flow field in accordance to an embodiment.

FIG. 12 illustrates a flowchart of an example process for a TWT negotiation for a P2P client in accordance with an embodiment.

FIG. 13 illustrates a flowchart of an example process for a TWT negotiation for a P2P Group Owner in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

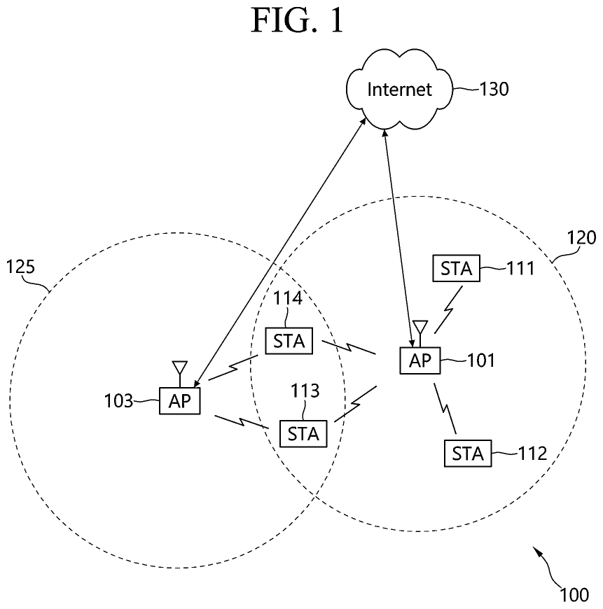

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

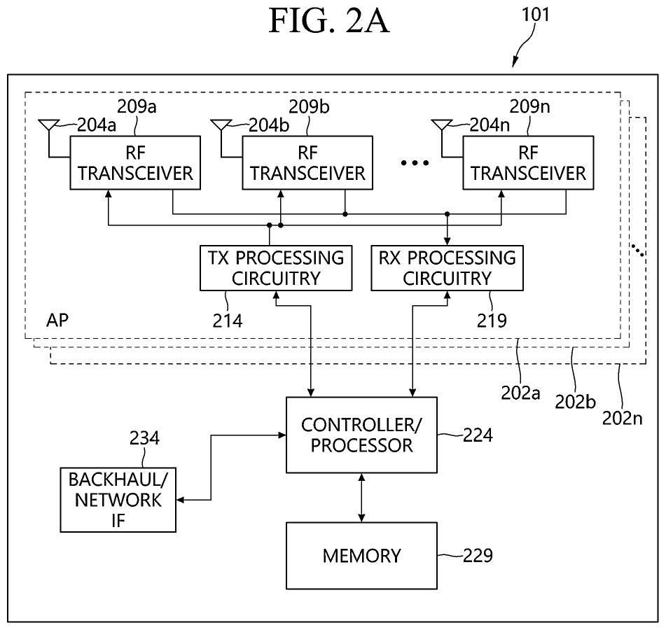

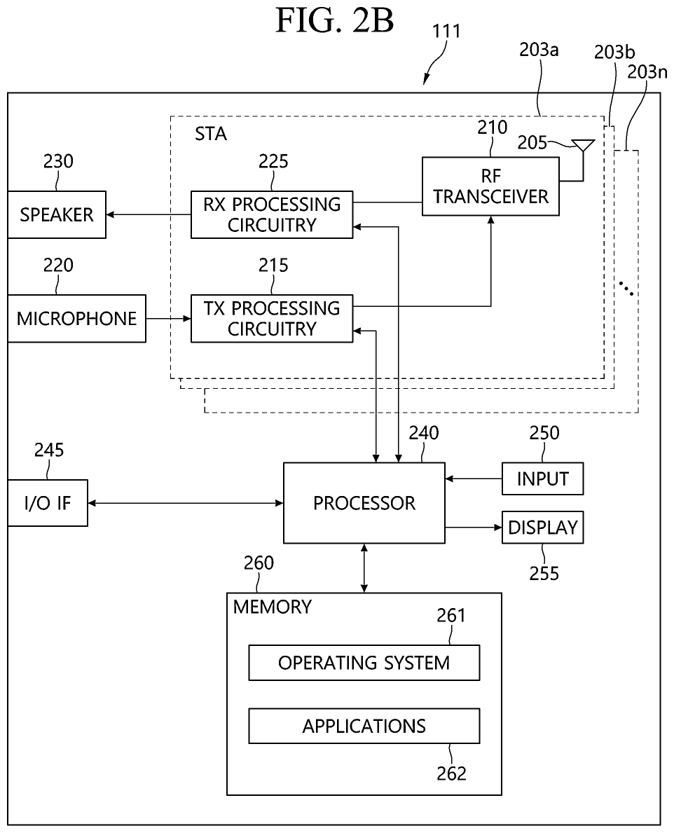

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

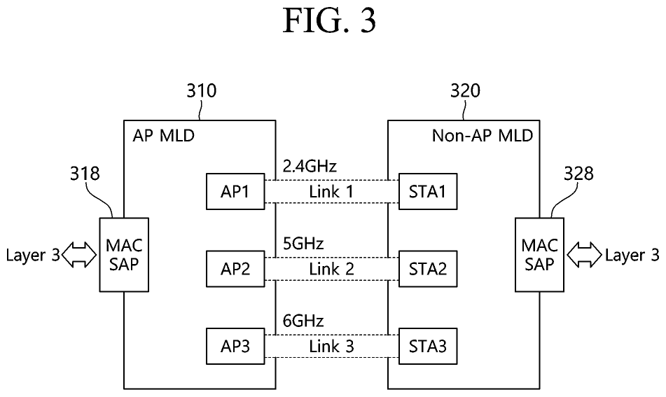

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

Target wake time (TWT) operation is a feature of power management in WLAN networks. The TWT operation has been introduced in IEEE 802.11ah standard and later modified in IEEE 802.11ax standard. The TWT operation enables an AP to manage activity in the basic service set (BSS) to minimize contention between STAs and reduce the required wake times for STAs during the TWT operation. It may be achieved by allocating STAs to operate at non-overlapping times or frequencies and perform the frame exchange sequences in pre-scheduled service periods. In TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during a TWT SP can employ any physical layer protocol data unit (PPDU) format supported by the pair of STAs that have established the corresponding TWT agreement, including, but not limited to, high efficiency multi-user physical layer protocol data unit (HE MU PPDU), high efficiency trigger based physical layer protocol data unit (TB PPDU).

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may take place on an individual basis between two STAs or between a STA and an AP. An AP may have TWT agreements with multiple STAs. Any changes in the TWT agreement between the AP and one STA do not affect the TWT agreement between the AP and other STA.

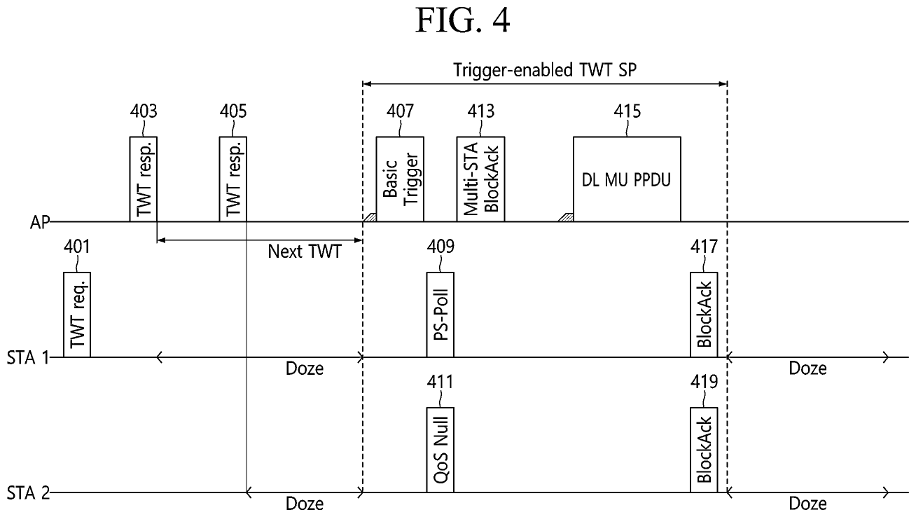

FIG. 4 shows an example of individual TWT operation in accordance with an embodiment. The operation depicted in FIG. 4 is for illustration purposes and does not limit the scope of this disclosure to any particular implementations.

In FIG. 4, STA 1 and STA 2 are TWT requesting STAs and AP is a TWT responding STA. In the example of FIG. 4, the STA 1 sends a TWT request 401 to the AP to setup a trigger-enabled TWT agreement. The AP accepts the TWT request 401 with STA 1 and confirms the acceptance in TWT response 403 sent to STA 1. Subsequently, the AP sends an unsolicited TWT response 405 to STA 2 to set up a trigger-enabled TWT agreement with STA 2. Both these TWT agreements are set up as announced TWTs. During the trigger-enabled TWT SP, the AP sends a Basic Trigger frame 407 to the TWT requesting STAs (STA 1 and STA 2) which may indicate that they are awake during the TWT SP. The STA 1 indicates that it is awake by sending a Power-Saving Poll frame (PS-Poll frame) 409, and the STA 2 indicates that it is awake by sending a Quality of Service (QOS) Null frame 411 in response to the Basic Trigger frame 407. Subsequently, the AP sends a Multi-Station Block Acknowledgement (Multi-STA Block Ack) 413 frame and Downlink (DL) Multi-User (MU) physical layer protocol data unit (PPDU) 415 to both STA 1 and STA 2. Afterward, the STA 1 and STA 2 respectively send BlockAck frames 417 and 419 to the AP, and then go to doze state.

The broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

The Wi-Fi Direct specification defines protocols for device-to-device or peer-to-peer (P2P) communication. A P2P network may include two kinds of devices, a P2P group owner (GO) and a P2P client. A P2P device may support the functionalities of both P2P GO and P2P clients. A P2P GO may include access point (AP) like functions, whereas a P2P client, while interacting with a P2P GO, may assume the role of a non-AP STA.

A P2P Group may include a P2P GO and one or more P2P clients. The clients in a P2P group may be connected to the P2P GO, where the clients can be either a P2P client or a legacy client. When a legacy client gets connected to a P2P GO, it is agnostic of the fact of whether the P2P GO is a P2P device or a legacy AP.

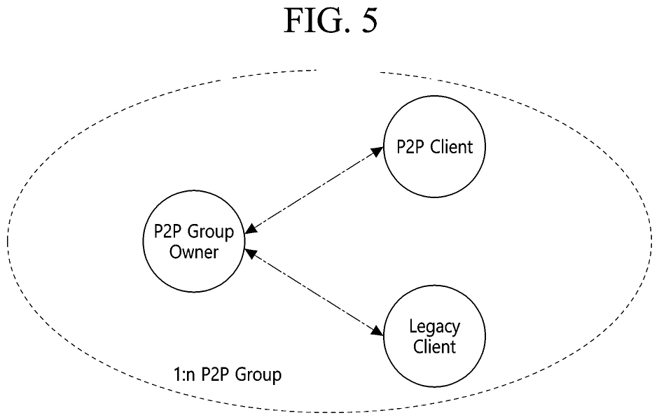

FIG. 5 illustrates a P2P client and a legacy client being connected with a P2P GO in a star configuration in accordance with an embodiment. In particular, FIG. 5 illustrates a P2P group, with a P2P GO connected with a P2P client and a legacy client.

In some embodiments, a P2P group can include a single P2P client and a GO.

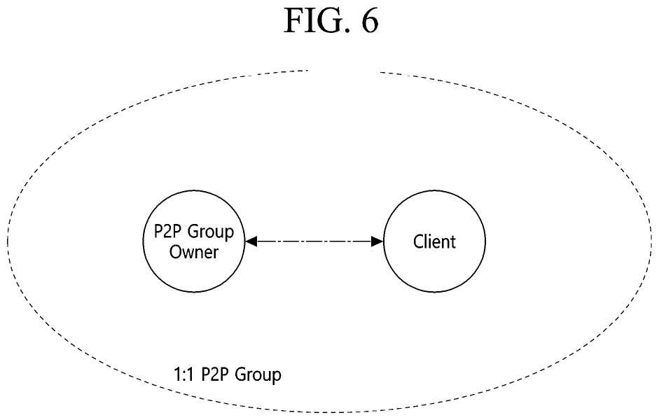

FIG. 6 illustrates a P2P group with only a client and a P2P GO in accordance with an embodiment. In FIG. 6, the P2P group includes a P2P GO communicating with a client. As illustrated in FIG. 6, the client may be a P2P device or a legacy device.

In some embodiments, in a typical deployment, both the P2P GO and the P2P clients may be battery-powered. Therefore, they may be a need for power-saving mechanisms. Accordingly, embodiment in accordance with this disclosure provide techniques that may allow individual TWT operations between a P2P GO and one or more P2P clients to thereby provide power saving opportunities.

In some embodiments, a P2P client in a P2P group can negotiate one or more individual TWT (iTWT) agreements with the P2P Group Owner. In some embodiments, for negotiating an individual TWT agreement, a P2P client can initiate the TWT negotiation. The P2P client can send a TWT setup request to the P2P Group Owner. The TWT setup request can be sent by sending a TWT Setup Request frame. In some embodiments, any of a variety of other frames that have similar functionalities as the TWT Setup Request frame may be used for TWT negotiation. A P2P GO that receives a TWT Setup Request frame from a P2P client can send a P2P setup response to that P2P client. The P2P setup response can be sent using a TWT Setup Response frame or any of a variety of other frames that may provide similar functionalities as the TWT Setup Response frame.

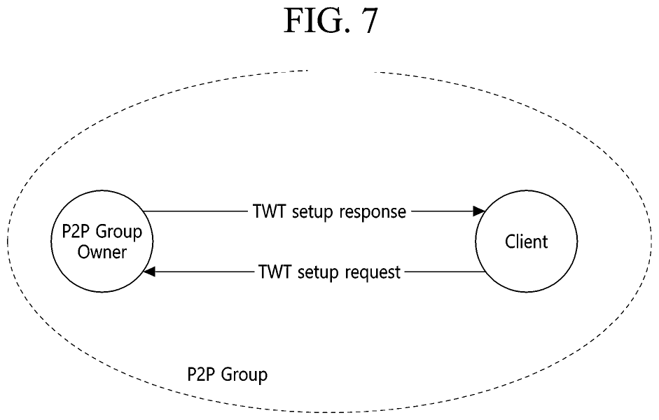

FIG. 7 illustrates an initiation of an individual TWT negotiation by a P2P client in accordance with an embodiment. As illustrated, the P2P group includes a P2P GO and a client device. The client may transmit a TWT setup request to the P2P GO and the P2P GO may transmit a TWT setup response to the client.

In some embodiments, for negotiating an individual TWT agreement, a P2P GO can initiate the TWT negotiation. In some embodiments, the P2P GO can send the TWT setup request to the P2P client. The TWT setup request can be sent by sending a TWT Setup Request frame or any of a variety of other frames that may provide similar functionalities as the TWT Setup Request frame. A P2P client that receives a TWT setup request from a P2P Group Owner can send a P2P setup response to that P2P client. The P2P setup response can be sent using a TWT Setup Response frame or any of a variety of other frames that may provide similar functionalities as the TWT Setup Response frame.

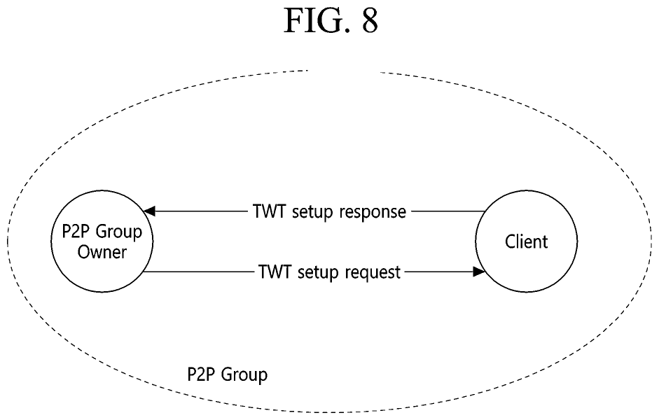

FIG. 8 illustrates an initiation of individual TWT negotiation by a P2P Group Owner in accordance with an embodiment. As illustrated in FIG. 8, the P2P group includes a P2P GO and a client device. The P2P GO transmits a TWT setup request to the client device. The client device transmits a TWT setup response to the P2P GO.

In some embodiments, a P2P client in a P2P group can negotiate one or more individual TWT agreements with another P2P client in the same P2P group. In some embodiments, a P2P client in a P2P group can negotiate one or more individual TWT agreements with another P2P client in a different P2P group.

In some embodiments, a first P2P client can send the TWT setup request to a second P2P client in the same or different P2P group. The TWT setup request can be sent by sending a TWT Setup Request frame or any of a variety of other frames that may provide similar functionalities as the TWT Setup Request frame. The second P2P client that receives a TWT setup request from the first P2P client can send a P2P setup response to the first P2P client. The P2P setup response can be sent using a TWT Setup Response frame or any of a variety of other frames that may provide similar functionalities as the TWT Setup Response frame.

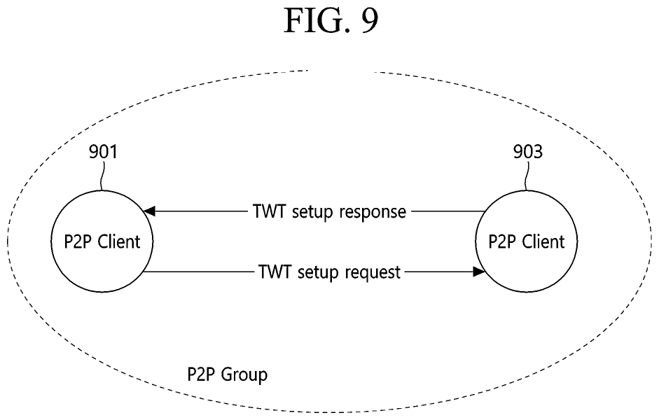

FIG. 9 illustrates an individual TWT negotiation between two P2P clients in accordance with an embodiment. As illustrated in FIG. 9, the P2P group includes two P2P client devices, including P2P client device 901 and P2P client device 903. The P2P client device 901 may transmit a TWT setup request to P2P client device 903. P2P client device 903 may transmit a TWT setup response to P2P client 901.

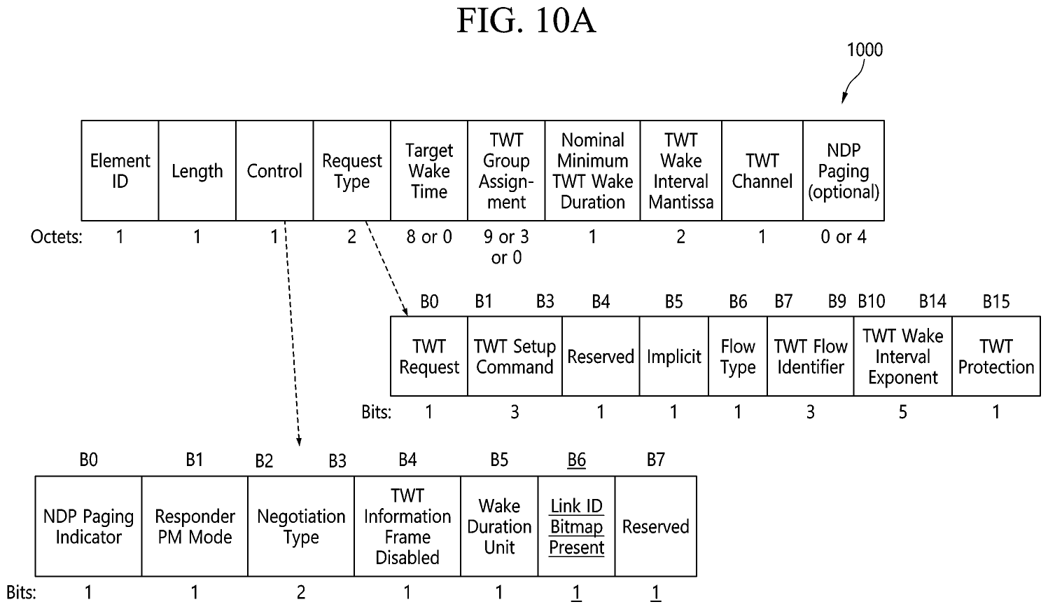

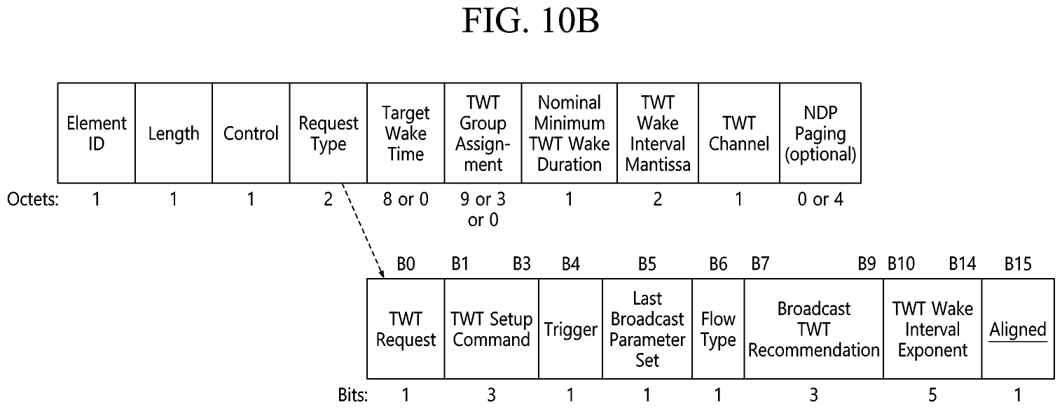

FIG. 10A shows an example of a TWT element 1000 in accordance with an embodiment. The TWT element 1000 may be applicable to IEEE 802.11be standard and any future amendments to the IEEE standard. The TWT element 1000 may be included in a broadcast frame, such as a beacon frame, an association response frame, a reassociation response frame, or a probe response frame, transmitted by APs affiliated with the AP MLD.

Details about each field and subfields of the TWT element 1000 are further explained below. In FIG. 10, the TWT element 1000 may include an Element identifier (ID) field, a length field, a Control field, a Request Type filed, a Target Wake Time field, a TWT Group Assignment field, a Nominal Minimum TWT Wake Duration field, a TWT Wake Interval Mantissa field, a TWT Channel field, and a NPD Paging (optional) field.

The Element ID field may include information to identify the TWT element 1000. The Length field may indicate a length of the TWT element 1000.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and a Reserved subfield. The NDP Paging Indicator subfield may indicate whether an NDP paging field is present or not in an Individual TWT Parameter Set field. The Responder PM Mode subfield may indicate the power management mode, such as active mode and power save (PS) mode. The Negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the TWT element 1000. The Link ID Bitmap Present subfield may indicate the presence of the Link ID Bitmap field in the TWT element. The TWT Parameter Information field of the TWT element 1000 may include either a single Individual TWT Parameter Set field or one or more Broadcast TWT Parameter Set fields 1020. In some implementations, if the Broadcast subfield of the Negotiation Type subfield in the Control field is 0, the TWT Parameter Information field includes the single Individual TWT Parameter Set field. Otherwise, the TWT Parameter Information field includes one or more Broadcast TWT Parameter Set fields.

The Request Type field will be explained in further detail below.

The Target Wake Time field may indicate the start time of the TWT service period (SP) on the corresponding link.

The Nominal Minimum TWT Wake Duration field may indicate the minimum amount of time that the TWT scheduled STA is expected to be awake in order to compete the frame exchanges for the period of TWT wake interval.

The TWT Wake Interval Mantissa field may indicate the value of the mantissa of the TWT wake interval value.

The TWT Channel field may provide channel information for the TWT.

The NPD Paging (optional) field may provide NPD paging information.

The Request Type field may include a TWT Request subfield, a TWT Setup Command subfield, a reserved subfield, an Implicit subfield, a Flow Type subfield, a TWT Flow Identifier subfield, a TWT Wake Interval Exponent subfield, and a TWT Protection subfield.

The TWT Request subfield may indicate if the transmitting STA is a TWT scheduling AP (or STA) or a TWT scheduled STA (or AP). The TWT Setup Command subfield may indicate the type of TWT command such as Request TWT, Suggest TWT, Demand TWT, TWT Grouping, Accept TWT, Alternate TWT, Dictate TWT and Reject TWT. The Reserved subfield may be a reserved field. The Implicit subfield may be used for an implicit TWT agreement. The Flow Type subfield may indicate the type of interaction, for example, an announced TWT or an unannounced TWT between the TWT scheduled STA and the TWT scheduling AP at TWT. The TWT Flow Identifier subfield may be used to provide a TWT flow identifier. The TWT Wake Interval Exponent may indicate the value of the exponent of the TWT wake interval value. The TWT Protection subfield may be used to protect the TWT element.

FIG. 10B illustrates another example of a TWT element in accordance with an embodiment. Many of the fields illustrated in FIG. 10B are the same as those provided in FIG. 10A. The Request Type field may include a TWT Request field, a TWT Setup Command field, a Trigger field, a Last Broadcast Parameter Set field, a Flow Type field, A Broadcast TWT Recommendation field, a TWT Wake Interval Exponent field, and an Aligned field. The TWT Request subfield may indicate if the transmitting STA is a TWT scheduling AP (or STA) or a TWT scheduled STA (or AP). The TWT Setup Command subfield may indicate the type of TWT command, such as Request TWT, Suggest TWT, Demand TWT, TWT Grouping, Accept TWT, Alternate TWT, Dictate TWT and Reject TWT. The Trigger subfield may indicate whether the TWT SP indicated by the TWT element includes triggering frames. The Last Broadcast Parameter Set subfield may indicate whether another Broadcast TWT Parameter Set field follows this Broadcast TWT Parameter Set field. The Flow Type subfield may indicate the type of interaction, for example, an announced TWT or an unannounced TWT between the TWT scheduled STA and the TWT scheduling AP at TWT. The Broadcast TWT Recommendation subfield may indicate recommendations on the types of frames that are transmitted by TWT scheduled STAs and TWT scheduling AP during the broadcast TWT SP. For instance, the types of frames may be PS-Poll and QoS Null frames, management frames, control response frames, or No constraints on the frame. The TWT Wake Interval Exponent subfield may indicate the value of the exponent of the TWT wake interval value. The Aligned subfield may indicate whether one or more of other links of the AP MLD have broadcast TWT schedules that are aligned with the corresponding schedule. More specifically, if the subfield is set to 1, it may indicate that there are one or more schedules on other links that are aligned with the TWT schedule identified by the Broadcast TWT Parameter Set field. Otherwise, the schedule is no such schedule on the other links.

Hereinafter, implicit TWT are described in accordance with several embodiments. In some embodiments, when a P2P device (e.g., a P2P Group Owner or a P2P client) in a P2P group negotiates an individual TWT agreement with another P2P device (e.g., a P2P Group Owner or a P2P client) in the P2P group, the negotiation may be for a TWT that has periodic TWT service periods (SPs). In some embodiments, such a TWT agreement can be considered as an implicit TWT agreement. In some embodiments, a P2P device can negotiate for an implicit TWT agreement by setting an Implicit subfield in a Request Type field in a TWT Parameter Set field in a TWT element.

Hereinafter, NPD paging are described in accordance with several embodiments. In some embodiments, when a P2P device (e.g., a P2P Group Owner or a P2P client) in a P2P group negotiates an individual TWT agreement with another P2P device (e.g., a P2P Group Owner or a P2P client) in the P2P group, then the P2P devices may not support Null Data Packet (NDP) Paging for the TWT. In some embodiments, for the negotiation of the TWT agreement, a NDP Paging Indicator subfield in a TWT elements can be set to 0.

Hereinafter, Triggered-TWT are described in accordance with several embodiments. In some embodiments, when a P2P device (e.g., a P2P Group Owner or a P2P client) in a P2P group negotiates an individual TWT agreement with another P2P device (e.g., a P2P Group Owner or a P2P client) in the P2P group, the negotiation can be for a Trigger-enabled TWT. In some embodiments, during the TWT setup, a Trigger subfield in a TWT element can be set to 1.

In some embodiments, a trigger-enabled TWT agreement may be established between a P2P Group Owner and a P2P client when the P2P Group Owner is the P2P responder and the P2P Group Owner, during the TWT setup, sends a TWT setup response to the P2P client with the Trigger subfield in the TWT element set to 1. The responding STA for a negotiation for a trigger-enabled TWT between two P2P devices in a P2P group is the P2P Group Owner of that group.

Hereinafter, sub-channel selective operations are described in accordance with several embodiments. In some embodiments, when a P2P device (e.g., a P2P Group Owner or a P2P client) in a P2P group negotiates an individual TWT agreement with another P2P device (e.g., a P2P Group Owner or a P2P client) in the P2P group, if both P2P devices support subchannel selective transmission (SST) operation, then the TWT negotiation can be subchannel-based TWT transmission. In some embodiments, the requested subchannel to be used during the TWT SP may be indicated by the corresponding bit in the TWT Channel subfield in the TWT element used for the TWT negotiation. If both the P2P devices don't support the SST operation, then the TWT Channel subfield in the TWT element exchanged between the P2P devices (P2P Group Owner or P2P client) can be set to 0.

Hereinafter, Network Allocation Vector (NAV) protection are described in accordance with several embodiments. In some embodiments, when a P2P device (e.g., a P2P Group Owner or a P2P client) in a P2P group negotiates an individual TWT agreement with another P2P device (e.g., a P2P Group Owner or a P2P client) in the P2P group, if the P2P devices intend to use protected Network Allocation Vector (NAV) for the transmit opportunities (TXOPs) within the TWT SPs, then the TWT Protection subfield in the TWT element exchanged during the negotiation between the P2P devices can be set to 1; otherwise, the TWT Protection subfield in the TWT element can be set to 0.

In some embodiments, when a P2P device (e.g., a P2P Group Owner or a P2P client) in a P2P group intends to negotiate an individual TWT agreement with another P2P device (e.g., a P2P Group Owner or a P2P client) in the P2P group, the Negotiation Type subfield in the TWT elements exchanged between the devices can be set to 0.

Hereinafter, power save behaviors at a client side are described in accordance with several embodiments. In some embodiments, when a P2P client has successfully established an individual TWT agreement with the P2P Group Owner, then the P2P client may be exempt from staying awake outside of the TWT SPs corresponding to the individual TWT agreement. In some embodiments, the P2P client may or may not stay awake outside of the TWT SPs.

In some embodiments, when a P2P client has successfully established an individual TWT agreement with the P2P Group Owner, then the P2P client may be expected to be and/or may be required to be awake during the TWT SPs corresponding to the individual TWT agreement.

In some embodiments, when a P2P client has successfully established an individual TWT agreement with the P2P Group Owner, then the P2P client may be exempt from a requirement of receiving the Beacon frames transmitted by the P2P Group Owner.

Hereinafter, power save behaviors at a GO side are described in accordance with several embodiments. In some embodiments, when a P2P Group Owner has established one or more individual TWT agreements with one or more P2P clients, the P2P Group Owner may not be expected to be available outside the TWT SPs corresponding to those TWT agreements.

In some embodiments, when a P2P Group Owner has established one or more individual TWT agreements with one or more P2P clients, the P2P Group Owner may be expected to be and/or may be required to be available during the TWT SPs corresponding to those TWT agreements.

In some embodiments, when a P2P Group Owner negotiates an individual TWT agreement with a P2P client, if the P2P Group Owner intends to be unavailable outside the TWT SPs corresponding to the TWT agreement, then the Responder PM Mode subfield in the TWT element used for the TWT negotiation can be set to 1; otherwise, the Responder PM Mode subfield can be set to 0.

Hereinafter, buffered BUs are described in accordance with several embodiments. In some embodiments, when a P2P client has successfully established an individual TWT agreement with the P2P Group Owner, if the P2P Group Owner has pending buffered BUs for that P2P client, then the P2P Group Owner can set the bit corresponding to the AID value for that client in the TIM element to 1 to indicate to the P2P client about the presence of such pending traffic.

Hereinafter, TWT teardown operations are described in accordance with several embodiments. In some embodiments, when a first P2P device (e.g., a P2P Group Owner or a P2P client) in a P2P group has established an individual TWT agreement with a second P2P device (e.g., a P2P Group Owner or a P2P client) in the P2P group, if the first P2P device intends to tear down the TWT agreement, then the first P2P device can send a TWT Teardown frame to the second P2P device. A TWT Teardown frame may be used to teardown a TWT agreement or TWT schedule established between P2P devices.

A format of a TWT Teardown frame in accordance with an embodiment is show in Table 1.

| Order | Information |
|---|---|
| 1 | Category |
| 2 | Unprotected S1G Action |
| 3 | TWT Flow |

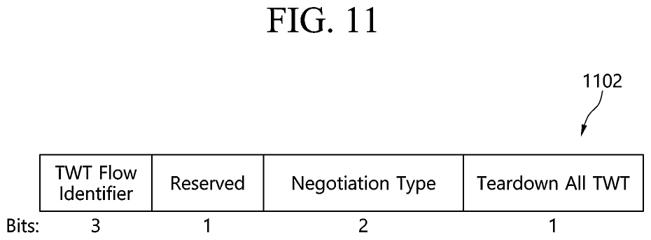

FIG. 11 illustrates an example format of the TWT flow field 1102 in accordance with an embodiment. The TWT Flow field 1102 in an example format for the TWT Flow field in the TWT Teardown frame of Table 1. The TWT Flow field 1102 may include a TWT Flow identifier subfield, a Reserved subfield, a Negotiation Type subfield, and a Teardown All TWT subfield.

The TWT Flow Identifier subfield may provide an identifier for the TWT.

The Reserved subfield may be reserved.

The Negotiation Type subfield in the TWT Flow field in the TWT Teardown frame can be set to 0; the TWT Flow Identifier subfield in the TWT Flow field can be set to the TWT Flow Identifier value corresponding to the TWT agreement that the first P2P device intends to teardown. If the first P2P device intends to teardown all the TWT agreements established with the second P2P device, then the Teardown All TWT subfield in the TWT Flow field in the TWT Teardown frame can be set to 1; otherwise, the Teardown All TWT subfield can be set to 0.

Hereinafter, unsolicited TWT operations are described in accordance with several embodiments. In some embodiments, a P2P Group Owner can send an unsolicited TWT response to a P2P client. In certain embodiments, the Trigger subfield in the TWT element in the TWT response can be set to 1. In the unsolicited TWT response, the TWT Setup Command field in the TWT element can be set to either Accept TWT or Alternate TWT or Dictate TWT. When the TWT Setup Command field in the unsolicited TWT response is set to either Alternate TWT or Dictate TWT, this may indicate that the TWT response is an advisory notification for the recipient P2P client. If the P2P client subsequently sends a TWT request with the parameters indicated in the unsolicited TWT response with the TWT Setup Command subfield set to either Alternate TWT or Dictate TWT, then the request is likely to be accepted by the P2P Group Owner.

In some embodiments, when a P2P Group Owner sends an unsolicited individual TWT response to a P2P client with the TWT Setup Command subfield set to Accept TWT, a new individual TWT agreement may be set up between the P2P client and the P2P Group Owner.

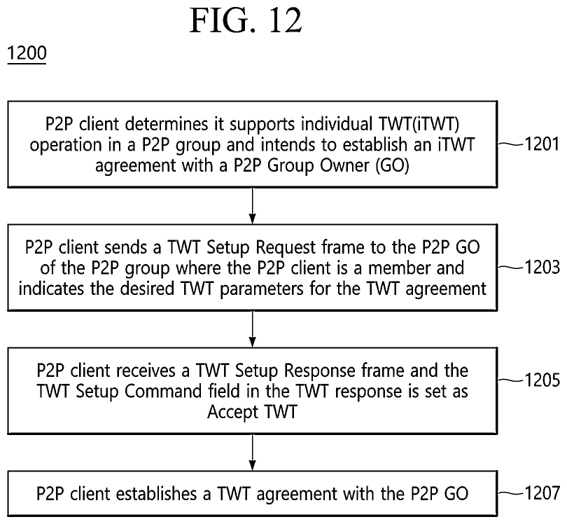

FIG. 12 illustrates a flowchart of an example process for a TWT negotiation for a P2P client in accordance with an embodiment. For explanatory and illustration purposes, the example process 1200 may be performed by P2P client depicted in FIG. 5. Although one or more operations are described or shown in particular sequential order, in other embodiments the operations may be rearranged in a different order, which may include performance of multiple operations in at least partially overlapping time periods.

The process 1200, in operation 1201, the P2P client determines that it supports individual TWT (iTWT) operation in a P2P group and intends to establish an iTWT agreement with a P2P GO.

In operation 1203, the P2P client sends a TWT Setup Request frame to the P2P GO of the P2P group where the P2P client is a member and indicates a desired TWT parameters for the TWT agreement.

In operation 1205, the P2P client receives a TWT Setup Response frame and the TWT Setup Command filed in the TWT Setup Response frame is set as Accept TWT.

In operation 1207, the P2P client establishes a TWT agreement with the P2P GO.

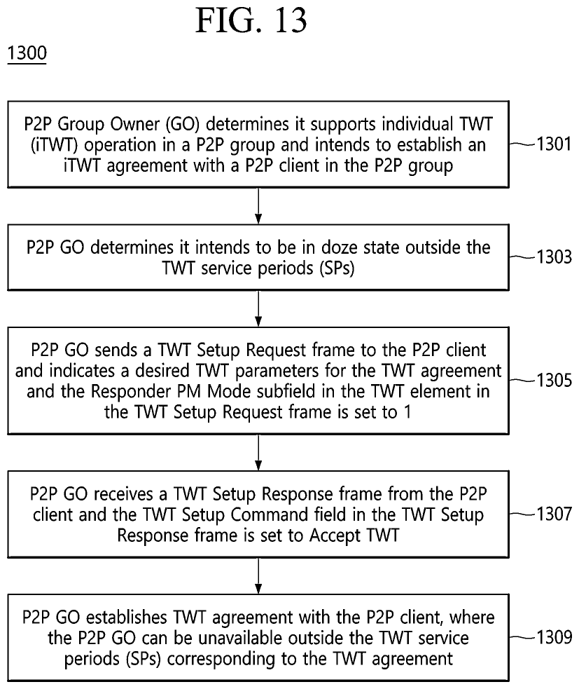

FIG. 13 illustrates a flowchart of an example process for a TWT negotiation for a P2P Group Owner in accordance with an embodiment. For explanatory and illustration purposes, the example process 1300 may be performed by P2P GO depicted in FIG. 5. Although one or more operations are described or shown in particular sequential order, in other embodiments the operations may be rearranged in a different order, which may include performance of multiple operations in at least partially overlapping time periods.

The process 1300, in operation 1301, the P2P GO determines that it supports iTWT operation in a P2P group and intends to establish an iTWT agreement with a P2P client int ch P2P group.

In operation 1303, the P2P GO determines that it intends to be in a doze state outside the TWT service periods (SPs).

In operation 1305, the P2P GO sends a TWT Setup Request frame to the P2P client and indicates a desired TWT parameters for the TWT agreement and the Responder PM Mode subfield in the TWT element in the TWT Setup Request frame is set to 1.

In operation 1307, the P2P GO receives a TWT Setup Response frame from the P2P client and the TWT Setup Command field in the TWT Setup Response frame is set to Accept TWT.

In operation 1309, the P2P GO establishes TWT agreement with the P2P client, where the P2P GO can be unavailable outside the TWT service periods (SPs) corresponding to the TWT agreement.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, the first STA comprising:
a memory;
a processor coupled to the memory, the processor configured to:
transmit, to a second STA, a first frame that includes a TWT element comprising one or more target wake time (TWT) parameters for establishing a TWT agreement, wherein the first STA and the second STA are in a peer-to-peer (P2P) network;
receive, from the second STA, a second frame that accepts the TWT agreement; and
establish the TWT agreement between the first STA and the second STA.

2. The first STA of claim 1, wherein the TWT agreement specifies TWT service periods (SPs) such that the first STA and the second STA are expected to be awake during the TWT SPs specified in the TWT agreement.

3. The first STA of claim 2, wherein the first STA intends to be in a doze state outside of the TWT service SPs specified in the TWT agreement.

4. The first STA of claim 3, wherein the first frame is a TWT setup request frame that includes the TWT element with a responder power management (PM) mode subfield that specifies whether the first STA intends to be in the doze state outside of the TWT service SPs.

5. The first STA of claim 1, wherein the second frame is a TWT setup response frame that includes a TWT setup command field set as Accept TWT.

6. The first STA of claim 1, wherein the first STA is a P2P group owner and the second STA is a P2P client in the P2P network.

7. The first STA of claim 1, wherein the first STA is a P2P client and the second STA is a P2P group owner in the P2P network.

8. The first STA of claim 1, wherein the processor is further configured to establish another TWT agreement between the first STA and a third STA that is not in the P2P group.

9. The first STA of claim 1, wherein the first STA and the second STA do not support null data packet (NDP) paging for the TWT agreement such that an NDP paging indicator subfield in a TWT element indicates that NDP paging is not supported.

10. The first STA of claim 1, wherein the TWT agreement is a trigger-enabled TWT agreement.

11. The first STA of claim 1, wherein the first STA and the second STA support subchannel selective transmission (SST) operation such that the TWT agreement is subchannel-based TWT transmission.

12. A first station (STA) in a wireless network, the first STA comprising:
a memory;
a processor coupled to the memory, the processor configured to:
receive, from a second STA, a first frame that includes a TWT element comprising one or more target wake time (TWT) parameters for establishing a TWT agreement, wherein the first STA and the second STA are in a peer-to-peer (P2P) network;
transmit, to the second STA, a second frame that accepts the TWT agreement; and
establish the TWT agreement between the first STA and the second STA.

13. The first STA of claim 12, wherein the TWT agreement specifies TWT service periods (SPs) such that the first STA and the second STA are expected to be awake during the TWT SPs specified in the TWT agreement.

14. The first STA of claim 13, wherein the first STA intends to be in a doze state outside of the TWT service SPs specified in the TWT agreement.

15. The first STA of claim 12, wherein the second frame is a TWT setup response frame that includes a TWT setup command field set as Accept TWT.

16. The first STA of claim 12, wherein the first STA is a P2P group owner and the second STA is a P2P client in the P2P network.

17. The first STA of claim 12, wherein the first STA is a P2P client and the second STA is a P2P group owner in the P2P network.

18. The first STA of claim 12, wherein the processor is further configured to establish another TWT agreement between the first STA and a third STA that is not in the P2P group.

19. The first STA of claim 12, wherein the first STA and the second STA do not support null data packet (NDP) paging for the TWT agreement such that an NDP paging indicator subfield in a TWT element indicates that NDP paging is not supported.

20. The first STA of claim 12, wherein the first STA and the second STA support subchannel selective transmission (SST) operation such that the TWT agreement is subchannel-based TWT transmission.
